(19) United States
(12) Patent Application Publication
(10) Pub. No.: US 2006/0167829 A1
(43) Pub. Date: Jul. 27, 2006

(54) Multistage network computer architecture, with user-centered remote operating system

(76) Inventors: Jean Levy Dreyfus, Le Pecq (FR); Didier Levy, Hythe Kent (FR); Haim Mamou, Paris (FR); Sacchetti Marc, Andresy (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/532,645

(22) PCT Filed: Oct. 27, 2003
(86) PCT No.: PCT/FR03/03190

§ 371 Date: Jan. 9, 2006

Related U.S. Application Data
(60) Provisional application No. 60/421,465, filed on Oct. 25, 2002.

(51) Int. Cl. G06F 17/30

(52) U.S. Cl. 707/1

(57) ABSTRACT

A multi-tier computer architecture is intended to allow access to a personal resources environment, via a network such as Internet from varied access points corresponding to different types of client workstations. The said computer architecture comprises: a standard relational database server tier comprising a database manager able to execute on request all operations on the data of the database, the which database contains, in a manner proper to each user, both data and documents constituting the unique and organised storage space of the user, and the database manager comprising remote operating system functionalities in relation with said storage space. a network communication tier comprising a communication server and a customer software able to communicate together in a standard network format, and a software intermediate server tier connected on the one hand to the database server tier, and on the other hand, to the communication tier and containing a set of servlets able, in response to requests from the communication tier, to cause via the database manager the remote execution of the functionalities of said system.

The present invention concerns in a general manner the data processing systems integrated into a network environment.

### BACKGROUND OF THE INVENTION

Originally, a multi-user data processing architecture was implemented in a central mainframe plus passive terminal architecture, to perform heavy duty processing for the corporate sector—calculation, data classification and extraction—to replace people.

Progressively, changes in technical architectures—mini-computers, personal computers, client/server software and ERP—made it possible to give strength and muscle to application solutions, so enabling enterprises to operate critical missions—such as management of accounts, production, communication, etc., by reducing the involvement and the individual know-how of the end-users.

After an appearance some twenty years ago and generalisation into personal computers (PC) in the 1990s, graphical interfaces by masking the complex language of data processing, and by displaying a visual representation of a personal desktop, have enabled end-users to perform, in an independent manner, a number of complex office automation and activity monitoring tasks.

Applications—word processing, spreadsheets, contact management, timetables, etc.—have been developed to make the PC a tool of personal productivity in the enterprise, by replacing classic office resources (typewriter, invoice register, etc.).

Originally capable only of asynchronous communication (printed documents, exchange of files on magnetic media), the PC was subsequently given applications—network protocols, electronic mail, groupware, security—developed to organise the navigation through, and transfer of, network data.

Enterprises have therefore been able to set up network architectures on a local and extended basis to perform tasks on PCs which were initially handed over to a passive terminal. They were able to concentrate the data processed on the workstations, at the mainframe computer level.

Subsequently “client/server” architectures were developed. In this mode, processing takes place on the client workstation, which assumes that there is sufficient processing power, and the installation of the correct operating system versions and parameters to run each work application, and that the end-user is competent.

For proper performance, there must be a combination of the right hardware, the right software, and the right know-how from the end-user.

Note in this respect that:

If one of these factors is missing, the information system is very much weakened, leading to unwieldiness, loss of information and the breakdown of digital communication.

Network operation costs are very high, as burdensome administration is required, with substantial security management (antivirus, back-up and anti-hacker surveillance) and hardware and software updates to keep pace with publisher upgrades on all workstations.

Finally, and above all, if the end-user is far from his or her personal workstation, he or she is not in a position to perform the task for which the information system was designed.

In this respect, there are of course emulation techniques, but which nevertheless add additional cost and unwieldiness to the network architecture.

With the deployment of the worldwide web, which operates in a similar manner on the various hardware platforms, and associated standard navigation (browser) technology, network communication has become far simpler.

There are applications enabling navigation on all types of PC, but also on all sorts of other equipment (telephone, personal digital assistants or PDA, automobile dashboards, decoders and digital TV sets).

Internet navigation makes it possible by simply selecting a link to gather information on a remote server and to display that information in screen form or pages containing new reactive links, at end-user request.

The mode of addressing servers is simplified and uses a double naming system (IP digital addresses and mnemonic addresses by domain name).

For correct execution it is therefore enough to have an internet navigator connected (its location is of little importance) and minimal end-user knowledge.

Thus any person that has already conducted a search or made a stock market order or ordered on-line a particular good or travel service, has the minimum skills required.

Indeed, by filling in headings on a form and submitting through a click, the user initiates the execution of software in a server about which he or she remains entirely ignorant (both location, operating systems, applications, etc.), and yet obtains the service result requested.

This availability of on-line services has enabled manufactures such as Microsoft, Oracle, Sun Microsystems, to anticipate the forthcoming advent of an all-Internet model.

This model has nevertheless been slow in taking practical form because, up to the present time, the access point, i.e. the navigator, remains an application in a local PC, which brings about the following limitations:

The navigator is not the unique point of access to all on-line services is (e-mail is for example, most often organised in an independent and distinct application).

The personal productivity software in the PC does not use the navigator as the point of access, and the user bears the full responsibility for the naming and classification of data which he or she produces locally or recovers via the network.

The navigator operates as a function of the local web station operating system—navigator behaviour differs in substantially from one machine to the next, to such an extent that the services developed in Java language, whose original ambition was to be universal—have to be differentiated according to the navigator and machines on which they are performed.

To date, the services currently available on Internet are of the following type:

Information orientations (search engine, aggregation of news and information)

Application orientations (transaction with remote electronic transaction server, access to corporate client server applications by emulation or using Internet protocols).

These services are not truly interactive, as they involve a mechanism of publication which is generally under the control of a specialist, the webmaster. In this way, information from an end-user can only be used by other users if it is introduced into or from a utility intended for this task. Or failing that, the webmaster filters it and re-inserts it by publishing it, which makes the set-up of a collaborative activity in real time difficult.

A new type of service, the Web service, is likely to develop soon. Unlike current transactions which are pre-parametered on the e-business site, and which the user accesses by personal browsing or navigation, the web service will execute a transaction by a specialist customised transaction (for example, independently searching across all companies for the best timetables and prices for a Paris-Tokyo plane ticket), on the basis of a request issued through a Web services search engine (typically a directory made up using a UDDI meta-service).

The new all-Internet architecture announced will not be deployable efficiently, except and unless:

Access to the Internet network is sufficiently permanent, reliable and rapid (note in this respect that operational IP protocol on Internet is also, in a private network, a particularly economic solution for deployment in a local network).

The navigator is the point of access to a service (portal) through which the end-user can initiate information processing, be it a matter of using an on-line application or service, or of operating a business software (Computer Assisted Design or manufacture, etc.), installed on the dedicated workstation.

The end-user is able actually through the portal service able to locate the whole of his or her habitual work environment, that is, on any client PC in the office, when on the move, or at home—or on any other terminal, provided it is equipped with a navigator (browser).

That services evolve to provide total interactivity and enable collaboration in real time (in other words, enable the user to insert his or her own information into the remote server, so that this information becomes immediately open to query and handling by other operators without intervention from a system administrator).

Finally, that connectivity procedures to Web Services be organised in such a way as to be simple, powerful and universal, without requiring elaborate known-how, like a search engine).

### SUMMARY OF THE INVENTION

The purpose of the present invention is to propose in a simple, economic and reliable manner, a transactional point-of-access protocol, able to issue, organise, store, recover and distribute all digital data in such a way as to render operational an all-Internet architecture which meets the above-mentioned criteria.

More particularly, the invention proposes a new server software infrastructure that replaces the operating system and the software habitually installed on a local workstation, and delivers to the end-user, for his or her personal needs in the professional context, all the personal productivity functionalities, of file and content management, of information sharing and of monitoring relationships with third parties, in the form of integrated and organised services, available on any terminal disposing of internet access by means of a standard navigator (computer, digital personal assistant, mobile telephone, interactive TV set or Internet connected games console, etc.).

More precisely, the invention proposes an optimised software infrastructure for such an all-Internet architecture, which transparently manages the personal and collaborative real-time digital organisation of each user identified as connected, from any fixed or mobile terminal (light client). The invention therefore proposes, in its first aspect, a multi-tier networked computer architecture intended to enable access to a personal resources environment via a network such as Internet, from varied points of access corresponding to different types of client workstations, the characteristics of which invention include:

A standard relational database server tier including database server able to execute a request for all operations in the database, which contains both data and documents in a manner personal to each user, by setting up an organised and single storage space for the user,

A communications tier on the network including communication server and client software able to communicate together in a standard network format, and

An intermediate software layer server tier connected, on the one hand, to the database server tier, and on the other hand, to the communication tier, and comprising a set of servlets able, in response to requests from the communications tier, to execute procedures corresponding to types of operation as pre-defined in the database manager, with various servlets corresponding to different types of client workstation.

In its second aspect, the invention proposes a multi-tier networked computer architecture intended to enable access to a personal resources environment via a network such as Internet from varied points of access corresponding to various types of client workstation, whose characteristics include:

A standard relational database server tier comprising a database server manager able to execute on request all operations on the database data, which database contains in a manner proper to each user, both data and documents, by setting up both an organised and unique user storage space and the database manager comprising the functionalities of the remote operating system relating to the said storage space.

A communication tier on the network, including a communication server and a client software with the ability to intercommunicate in a standard network format and

An intermediate server software tier connected on the one hand to the database server tier, and on the other hand to the communication tier, comprising a set of servlets able, in response to requests from the communication tier, to cause the database manager to, remotely execute the functionalities of said system.

The client software is typically a standard Internet navigator.

Preferably, the communication tier defines two distinct communication channels. On the one hand, for the graphical interface information specific to each type of client workstation, and on the other hand, for the data or document outgoing to the client workstation or incoming from the client workstation.

Another preferred aspect of the invention is that the said user storage space contains, within the database, all the files executable by standard applications, either at the database server level, or at the client workstation level, and end-user data.

Thus, under the invention, a server houses a database and the whole logic of the client workstation operating system, thus enabling transparent data-handling from the moment of the data is generated, in the form of data classification, saving, selection and inter-relationship.

Thus, the service user at the appropriate time acts upon the information which is relevant, and capitalises it automatically, without ever being concerned as to its organisation.

The server facilitates the end-user's operations and handles the processing of the data which the end-user controls from the time of connection and throughout the session.

The use of the system under the invention requires from the end-user very little know-how, which is the opposite of what is required by the user of the current architecture, which piles up personal workstations—heavy and complex client workstations—into a network structure which is erratic and weakly administered.

By directly restoring into a Web page, in a structured manner and with the required power and security of processing, the elements of the central relational database, the approach of the present invention frees the user from the responsibility of digitally organising the information and enables the user to be efficient everywhere and at all times, even and above all when remote a dedicated personal computer, as the access and functionalities will be identical from any workstation.

The present invention has many applications.

In the first place it is intended for individuals, family and small enterprises: the systems simplifies and democratises the interactive use of Internet, as it brings together in a transparent manner applications running (ASP) and Web services, handles data storage and extraction in a server, and requires only few resources on the client workstation.

The system proposed as an OEM feature will be of benefit to operators and manufacturers, facilitating the development of their integrated services Web platforms for the private consumer market.

The platform is thus able to deliver—through a simple-to-use, personal portal, even without apprenticeship and from any workstation, be it at or away from home—a collection of services of fundament use to private users, to family groups and/or to very small enterprises. These services may be:

Secure electronic “storehouse” services, including the management of access privileges, containing individual and family information: e-mail messages sent and received, address books, photos, various documents, bank accounts, favourite sites, etc.

Intelligent search engine enabling retrieval of any information contained in the storehouse on the basis of multi-criteria search.

E-mail read, write and transmission services (e-mail client similar to application known as “Outlook Express”—Registered trademark).

Word processing services, photo display, family budget management, all these services being organised in such a way as to record, classify and automatically retrieve information in the storehouse.

SMS transmission services, Chat (instant messages), video phoning.

Services for the presentation of information from searches or from the aggregation of Internet documents.

Secure payment service operating on initially entered parameters with record of transaction in the electronic storehouse, etc.

Customer “kiosk” services (type Minitel—Registered trademark) for access to on-line services from sites known to the user and to Web services.

Two-way single person communication between each individual and his or her digital universe, made possible on the one hand through the independence of the user in respect of the physical ownership of a personal storage space (typically hard disk on a computer on which to store information in file form), and on the other hand, due to the identification and authentication of the user by the server, and not by the client workstation used by the server. Hence the invention will easily find its place in respect of assistance systems for developing countries.

The benefits of the invention in the consumer public context are numerous:

The end-user's life is simplified as he or she does not need to either know or be in control of the operating system, of the file classification tree structure, nor to install applications, and has no security concern (virus—loss of data).

The platform is available from inter-communicating equipment such as PC, personal digital assistant with communications facility, digital TV, mobile telephone, GPRS/imode, etc. The nature and presentation of the services are thereby adjusted to the terminal used in the manner inherently familiar to that system, but the data used remain the same, namely extracted from the subscriber's personal electronic storehouse.

A simple decoder—cable, satellite or digital terrestrial television with modem for transmission of information—, equipped with a Web navigator and a Java virtual machine, enables access from a television set to all services, as does a PC, and there is no need to equip the decoder with unwieldy resources (hard disk, random access memory, disk drives) to execute applications, to store files and data and to install new software; furthermore, it will not be necessary to upgrade the decoder for every new generation of processor, operating system and software; furthermore, the user account is accessible at a later date, from a PC navigator for example, to edit images and display them later or in another place on a television screen.

Each end-user is identified by the server, irrespective of his or her connection terminal (PC, decoder, GPRS, etc.), and it is easy to manage the authentication controls enabling on-line risk-free payments (data circulating between the navigator and the server are encrypted and made secure on a default basis).

Finally, by locating all the system's digital intelligence on the operator server, it becomes possible to discriminate access to services and hence to invoice them in a step-by-step and automatic process.

In the second place, for use by business corporations, administration and local authorities: once true interactivity is achieved on the Internet, the secure and intelligent virtual office becomes a concrete reality, with its ability to coordinate, facilitate and organise the personal productivity of staff, the sharing of information between them and the monitoring of relationships with third parties (clients—suppliers—administration etc.). The invention makes it possible to organise and manage collaboration, as an enterprise critical mission.

The invention also enables the enterprise, and more generally any professional or administrative organisation or association, to centralise on its server—whether dedicated or hosted—the easy (and low cost) integration of the following tasks and functionalities (the list is not exhaustive);

Management of directories and access authorisations (unique registration)

Virtual user desktop via simple navigator (light client)

Centralised storage disk with all-criteria research engine

Customer relationship management, third party management, sales force automation

Organisation and collaboration via groupware and timetable monitoring (timeflow)

Electronic secretariat and document management (Electronic Document Management)

Initiation and control of enterprise application information (EAI)

Internal and instant e-mail (Chat—IRC) hosted on the enterprise server

Automation of e-mails attached to Clients and Projects contexts

Work group irrespective of whether in local and/or extended network

Replicated management of nomad workstations working off connection

Access and data security, redundant back-ups.

The benefits of the present invention in the framework of professional use are numerous.

In the first instance, by means of on-line services integrating the whole digital organisation of the enterprise, the system of the invention provides enterprises with a simplification of their organisation and their procedures, even for remote staff, which is of itself a very important source of savings and provides for rapid return on investment.

In the second instance, its implementation is of the greatest simplicity insofar as the invention may be presented in the form of a software brick to be installed on a server (such as an “Internet Appliance” for Linux or a server for Windows 2000), physically installed in the enterprise, or hosted by a service provider. The installation of the service can be extremely rapid, and the necessary parameter settings are then made by the IP protocol from any light customer client workstation.

Thirdly, the invention offers an economic solution insofar as it does not require the acquisition of new hardware or software on the client workstation, nor remote emulation server (such as Citrix or Microsoft TSE).

Fourthly, the invention makes it possible progressively smoothly and seamlessly adapt, to the extent that the server party may connect to pre-existing enterprise data sources (Exchange, Domino, LDAP, Management under relationship database management systems, etc.), so enabling introduction and progressive deployment compatible with data custody, information databases, document models, existing procedures and organisation charts.

Fifthly, the invention offers a solution which is enterprise customisable and scaleable. The invention easily supports large work groups, by means of its deployment on appropriate servers and on relationship database management systems.

Sixthly, the integration, administration and customisation of a system under the invention are easy: maintenance is limited to a single server (no intervention on client workstation), and the work of the administrator is considerably facilitated, enabling the administrator to concentrate on the integration and creation of tailor-made requests intended to optimise the activity of the service.

Seventhly, the invention offers an excellent level of security, as all transactions can be executed in a virtual private network (VPN) by an anti-virus and firewall protected server. In addition, the data transmitted by the Web are compressed in an advantageous manner, and rendered secure by the SSL protocol or other.

Eighthly, the management of access privileges offers effective anti-hacker control. But above all, the system of the present intervention, unlike classic group ware applications, prevents the user organising data in a personal tree structure, and avoids the alteration or destruction of a structure of the enterprise data.

Finally, the invention proposes a system which adapts to specific the needs and models of the enterprise, by enabling discrimination between the rights of those accessing it, and to deliver to the Client workstation differentiated access—Extranet or Intranet—providing pages (in particular HTML) containing specific and different services according to the user connected.

It is therefore possible to offer either only a display of the results of XML requests, or the possibility of using only a part of the services. For example, an enterprise final client with Extranet access may by the same system be able to access only the internal email system (Memo Express—see below) and instant messaging (IsW Chat—see below) to make contact with the Hot Line technician; furthermore, all transactions will be automatically recorded in the file for this client.

The present intervention may be implemented either by a classic server application, or by an encapsulable server application which enables publishers, network operators, etc. in an efficient economic and immediately available manner, to bring to market a new personalised offer provided with the integrated services of the invention, by means of a simple navigator.

Other advantages of the system of the invention, as compared to the current state of technology, are shown on the table Appendix B attached.

### BRIEF DESCRIPTION OF THE DRAWINGS

Other aspects, aims and advantages of the present invention become more apparent on reading the detailed following description of the implementation of this invention, in its preferred form, which is given as an example, although its implementation is not limited to that form. Reference should be made to the attached drawings, in which:

FIG. 1 is a block diagram of the infrastructure and functions of a system set up according to the invention, and

FIG. 2 is a block diagram of the general architecture of the system according to the invention.

### DETAILED DESCRIPTION OF A PREFERRED EMBODIMENT

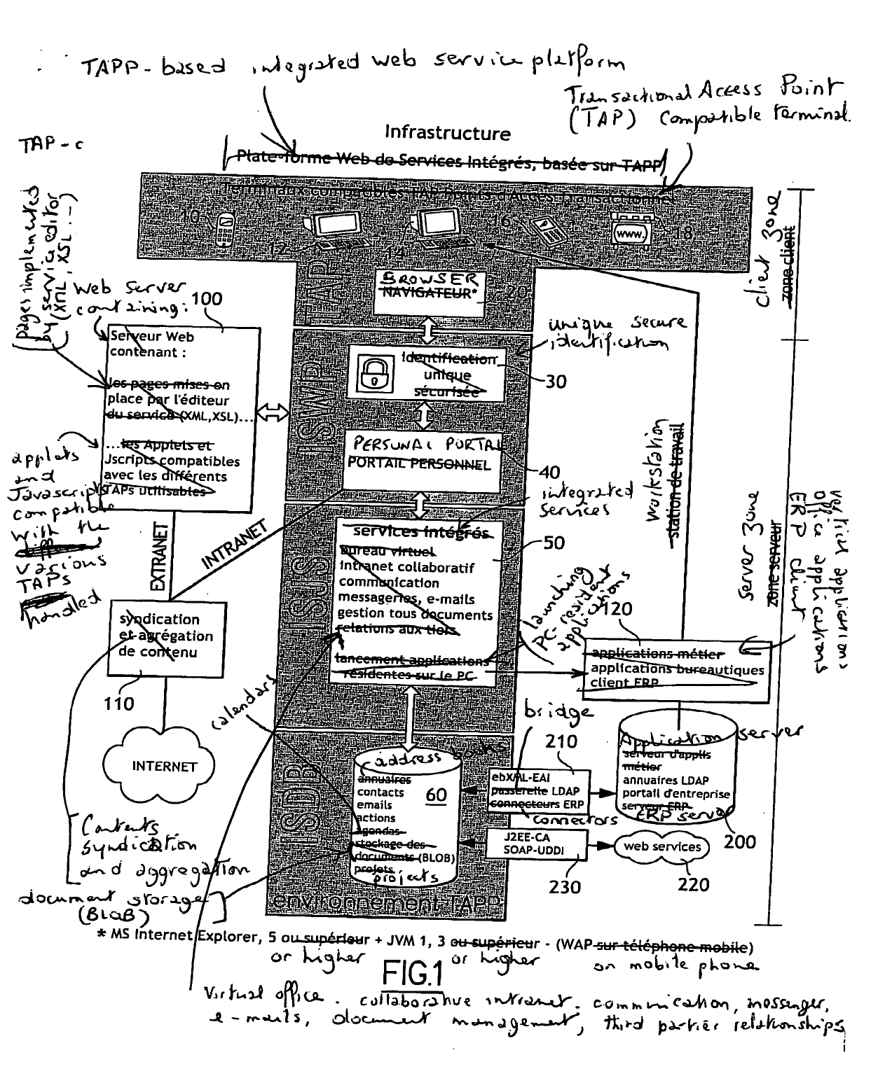

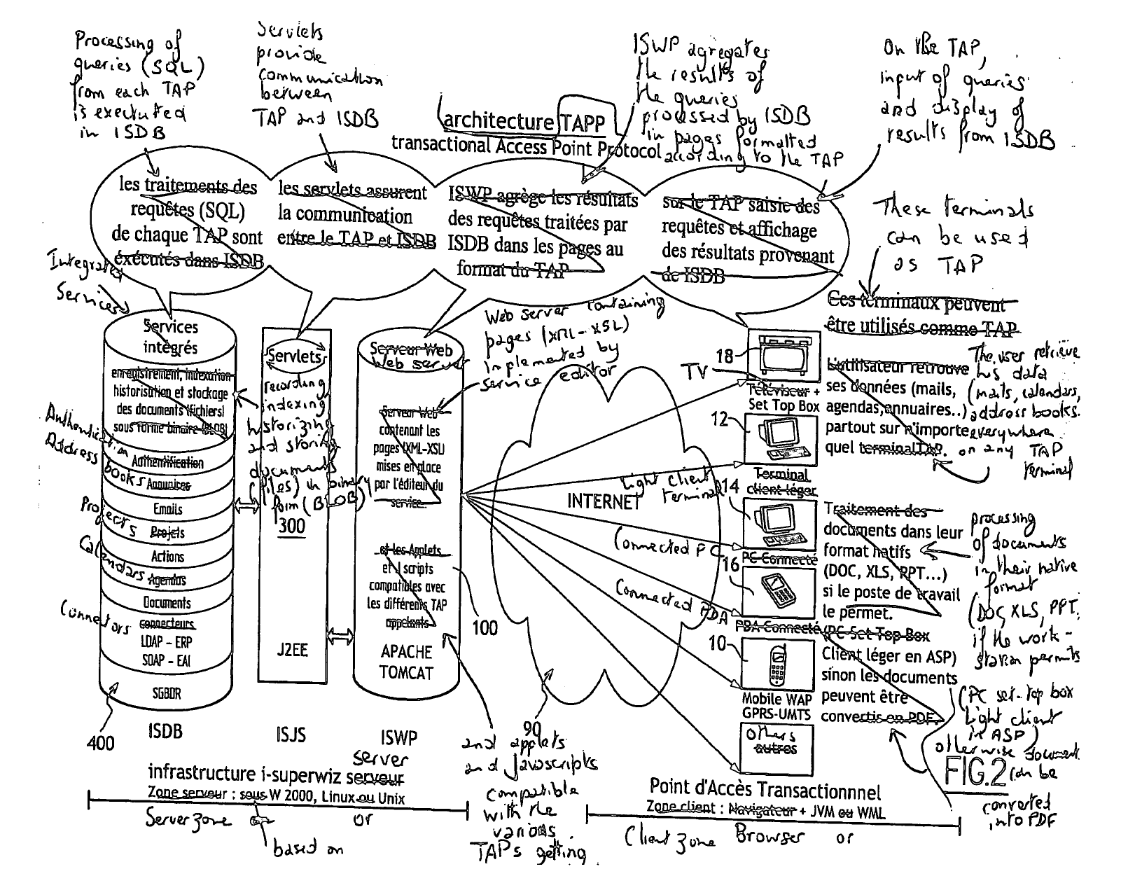

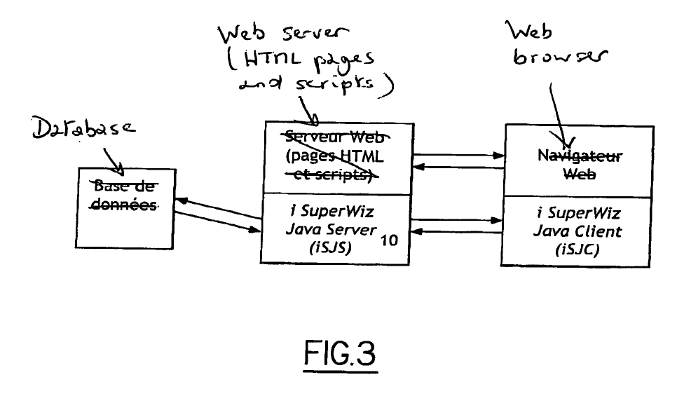

By reference first to FIG. 1, a representation is given in the upper part of a choice of communicating data processing equipment (client equipment), and in particular a GPRS or UMTS 10 mobile telephone, network 12 terminal, desktop computer or PC 14 type portable computer, personal digital assistant 16 or smart television 18.

Any one of these items of hardware, by means of software navigator 20 (for example, on an office PC or portable, an off-the-shelf navigator such as “Internet Explorer” (Registered trademark), provided with a Java virtual machine (Registered trademark), may communicate with a “personal portal” 40 by means of a secure link 30 based on a unique identifier protected by password or encryption.

This portal 40 cooperates functionally with an integrated set of service applications 50 (management of virtual desktop, collaboration via Intranet, communication, electronic messages including e-mail, document management, relationships with third party, etc.—see detailed description below), presenting the further ability to initiate resident applications on client hardware. The whole 50 relies on a relational database management system 60 containing among others, directory data, third party contacts, e-mails, actions, diaries, projects, files executable by given application (preferably in the form of Binary Large Objects (BLOB), in such a way as to provide the end-user, through a unique interface, with access to the various consultation, creation, modification, sorting, etc. services of these various types of data and documents.

The personal portal 40 and the associated secure link 30 are implemented by a Web 100 server communicating by Extranet with a software module 110 for content syndication and aggregation, itself accessing Internet. This Web server houses pages (HTML, XML, etc.) which will be proposed to the end-user, and sets of Applets or Javascripts suited to the type of client hardware from which the end-user is connected to the portal.

The portal 40 also enables the user to use specific business applications 120, themselves reliant on an ad hoc system 200 with the ability to execute these applications and all ancillary applications such as LDAP type directory, Web services, etc. The database 60 of the system of the invention communicates with the system 200 through the intermediary of all appropriate tools 210 such as ebXML, EAI, LDAP gangway, ERP connectors, etc.

Furthermore, the database management system 60 is able to communicate with the Web services 220 by the interfaces 230 based in particular on the Java J2EE platform, the SOAP protocol, a CA interface or further UDDI type meta services, etc.

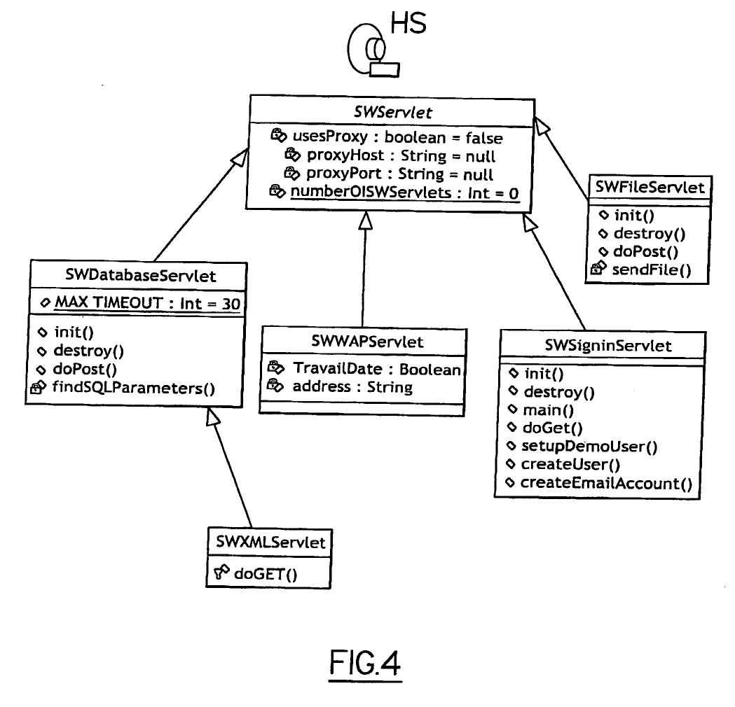

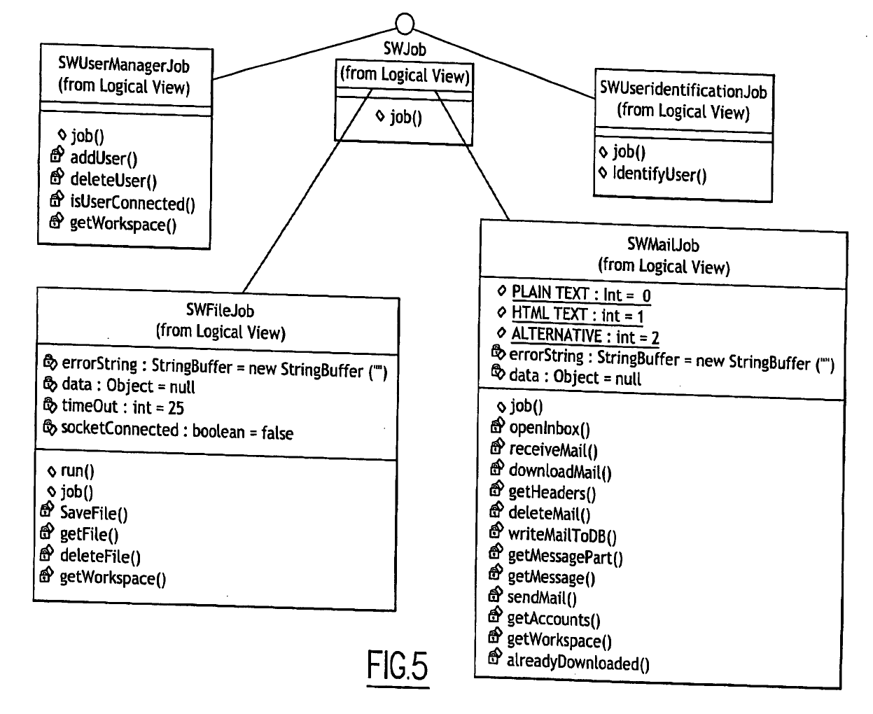

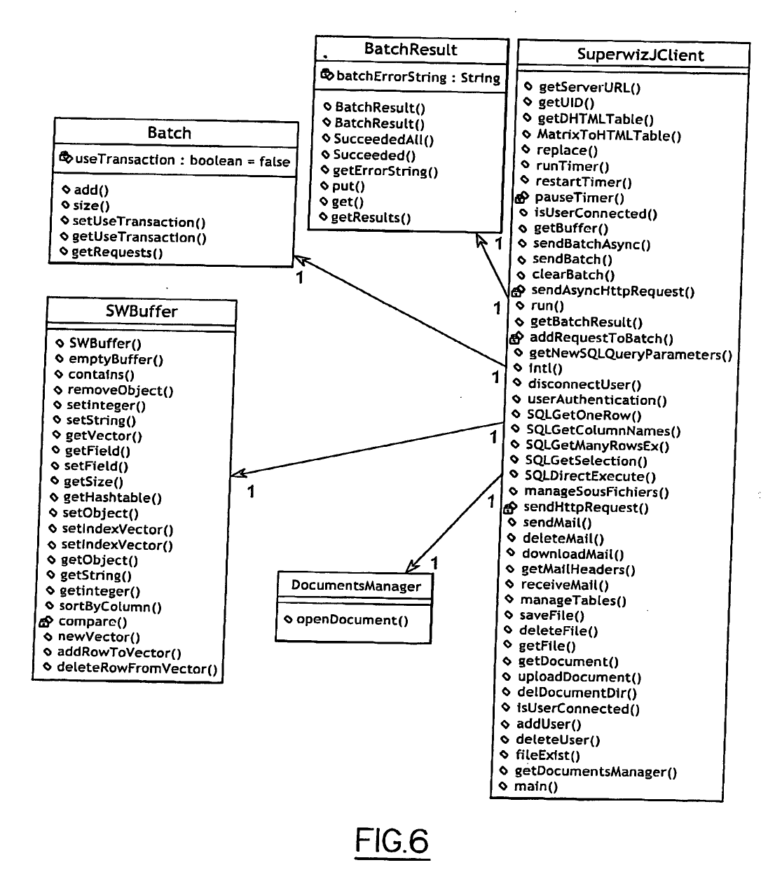

System architecture is illustrated in FIG. 2.

Client hardware 10 to 18 is illustrated on the right-hand side.

Client hardware communicates with Web server 100 through a transactional access point (TAP) by means of Internet 90. The server 100 contains the pages set up by the invention's integrated services publisher. This server is functionally connected to a communication module 300 constituted by a set of servlets set up on a J2EE type platform enabling the server 100 to communicate with the database management system 400, combining elements 60, 200, 210 and 230 of FIG. 1.

Such a system has the ability to make available to each user to a multiplicity of integrated services delivered by the server, depending on the user's rights and access privileges in the working group to which he or she belongs, or depending on the subscription taken out, from any client terminal featuring a simple Web navigator.

The various integrated services will now be detailed.

Single Sign On Express

To access the services of his or her enterprise or the services to which he or subscribes, the user must enter his or her identifier, password and the domain to which he or she belongs. Depending on access privileges, he or she will see displayed a Web page presenting a personal updated virtual desktop; the system is designed as a collaborative Intranet server, but may also be programmed for Extranet services in such a way as to display screens featuring restricted functionalities for users that do not belong to the Intranet work group (Clients, suppliers, subcontractors, etc . . . ), or for ASP applications.

Personalized Virtual Desktop

By default, the desktop user side of the system masks the navigator interface to allow the user to operate the services even if he or she has no computer skills. The desktop displays the user's diary for the day and actions and projects to be followed-up during the day. It enables access to services by a simple click of the mouse.

Directory Manager

This services automates the import, export, creation and search for data of various types in a system of directories proprietary to the enterprise. These parameters can be set, on a customer basis, by the service administrator. They contain information relating to any third parties in contact with the enterprise. Third party categories are clearly, in the first instance, customers and prospects, but also employees (including services users), suppliers, subcontractors, advisory services, government departments, etc.

The directories serve as a basis for Customer Relations Management, provide powerful search tools and automated links with all the other tables in the database (tables of contacts, projects, documents, table of e-mails, table of actions and sub-files as customised).

Project Manager

This service automatically and transparently brings together all the information related to a project—reports, comments, likelihood of concluding a deal, forecast budget, documents sent and received, including documents scanned, incoming and outgoing e-mails, actions related to the project, etc.

A project is automatically attached to a third party concerned, to a user with responsibility for a project, to a catalogue by type of activity, to a schedule of enterprise projects and to sub-files containing information exchanged with other enterprise applications. The user may perform multi-criteria search in the projects, and undertake classification, sorting and the necessary reports at the right time.

Document Manager

This service organises, stores and recovers documents in the context of projects. It enables the re-importation of any document created outside connection, and document insertion into the database, integrating it into the project follow-up. It automatically and transparently manages the creation, naming and storage of new enterprise documents.

This service remotely downloads document models from the invention's server, initiates the locally installed application, merges (for example in MS Word or Excel—Registered trademarks), and names the new document created, in compliance to the database rules. Once the user has completed his or her work on the document, the document is automatically downloaded to the server and deleted from the local machine.

The documents are linked by the database to third party receivers, to projects, to issuing users, to the type of document and to the chronology. Multi-criteria searches can take place on documents. All the necessary classifications, sorts and reports can be undertaken at the appropriate time from any workstation whatsoever.

Task Manager

This service automatically and transparently attaches tasks and things to be done, as part of the customer relationship management process and for work group operations. For example a task may send an SMS type mini-message to the user's mobile phone. Deferred tasks (time and duration) are displayed on the end-users diary.

Tasks are related to projects, to users (such as the requestor or operator of an action), to third parties and contacts. Searches for tasks can be performed according to all intended criteria. The tasks of the day are visible from the user's home page.

Diary Manager

This service provides diaries and schedules (personal or group) which may be displayed by day, by week or by month. Reading hourly slots is facilitated by colour diagrams. Diaries are related to users and tasks. The user's diary of the day is displayed in the home page.

Memo-Express

This service offers the enterprise an asynchronous private electronic mail system and a log of telephone calls. It enables limitation of useless and non-secure e-mails between members of a working group and accelerates the processing of messages related to the customer relationship. A Memo-express action is of a particular type and is consequently wholly linked to its project, to its contact and to its third party. As soon as the memo is sent, it appears in the user's home page, and can be displayed on screen (provided the receiver is connected).

E-Mail-Express

This service enables the user to receive and send e-mails from any computer (like a Web mail service would do). This service also enables the user to read only e-mail headings without having to download them in whole, and to select those that it is wished to read. This avoids the unwelcome effects of spam advertising e-mails that clog up mailboxes, and viruses on incoming e-mails, by deleting suspect and/or useless messages.

Finally, every e-mail received or sent is automatically connected to the relevant project, folder or third party in the database. This avoids sending CCs for information purposes, whose effect is to saturate the mailboxes of each member of the working group, and takes up their time to keep abreast of unnecessary information when read, or lost at the time when the information would actually be necessary. E-mails are related to projects, to users (whether senders or receivers), to third parties and to contacts. Naturally, the service enables all forms of multi-criteria search in the e-mail history of all the actors (on the basis of a hierarchy of access rights and privileges).

Search Express

This service is available, depending on hierarchical rights and privileges, in most pages. It allows one to perform requests as and when required in the database, for a word or a character string, or based on requests pre-defined by the enterprise.

The SQL search engine has the capability to locate any information from any criteria from any table in the enterprise database (and from an LDAP server of from a Domino Notes type database (Registered trademark), or from another database if an appropriate gangway is set up.

Report Express

This service proposes all sorts of preferred solutions under XML standard (“extended Markup Language”) in response to enterprise demands for the publication of tailor-made reports. The report so-obtained may be displayed in the form of an HTML page, or automatically displayed using an application such as MS Excel (Registered trademark) when run on the local workstation.

The services may also be saved in the form of a CSV text file for later use.

Personal Notepad

This service provides the user with a totally private and personal notepad, which can contain e-mail signatures, private reminders or other, etc. This notepad could contain text, HTML format data, etc.

Wizards

This service proposes all forms of utilities dedicated to marketing studies, sales and statistics.

Administration Dashboard

This service is a very easy to use on-line functionality, offering the enterprise database administrator very powerful tools to control and manage the system database parameters of the invention, as well as user rights and privileges. It requires a good knowledge of the database, but requires no training the programming field.

Info Service

This service, particularly at manager's request, enables sending information in “push” mode from the server to end-users; rotating information banners (type Reuter—Registered trademark) are displayed on the user's virtual desktop. A click on the banners displays their contents (in HTML format); at that precise instant, the server registers that information has been brought to the knowledge of the user (that person may if necessary not be displayed on a mandatory basis at the time of later sessions); an information note will cease being circulated depending on the validity date allocated to it by its issuer; all information circulation is recorded in a database. Hence the information can be the subject of requests, like any other type of document.

Chat

This is an instant messaging system (IRC) similar to the third party services proposed by operators such as AOL, ICQ or Yahoo, but completely independent of them; this Chat service is closely linked to the system database; it enables connected end-users to dialogue among themselves.

An application of this Chat service involves setting up a smart Knowledge Management tool for storage of all conversations in the heart of the database, indexing their content and finding precise information, using the above-mentioned Search Express search engine.

Another functionality is to enable automatic cut/paste of the contents of a chat session into an associated project, and hence into the client accounts to which this session and project are connected.

There is also the future and advantageous possibility of a voice Chat service between members of working groups, which would be a true on-line audio conferencing system, subject to the terminal to which the user is connected having the appropriate resources. Given substantial bandwidth, this could give rise to videoconferencing services.

To summarise, the present invention defines a universal transactional access point enabling a separation of content (i.e. information of interest to the user) from the content containers (i.e. the files masking the content), and enables more end-to-end fluid information circuits.

An analogy can be made to the telephone field, where whatever the end-user interface (digital keyboard, touch keyboard, dial or taxiphone), it delivers the same type of service (generally connecting another telephone by analog and/or digital link) without the user being required to organise the identification of the called post nor of the content, for the service to work at the other end of the line—and similarly for data transmission—, because the required modulation and demodulation are organised by the system.

The system of the invention can be totally compatible with the existing operating system, and does not involve the acquisition of now technology client side.

Below is an example of the practical application of the invention, accompanied by a more detailed technical description of the system invention.

### EXAMPLE OF APPLICATION

We shall now describe the application of the invention to an information system and organisation for collaborative work, and to the handling of the customer relationship, particularly in the small and medium sized enterprise sector.

A—General Description

1. Presentation

Similar to the Integrated Management software packages which are reserved, due to their very high acquisition and deployment costs, to big companies, the invention proposes to small and very small enterprises the easy integration of the following tasks and functionalities:
Customer relationship management and project follow-up
Directory management and diary monitoring (“timeflow”)
Organisation of working groups (or “groupware”)
Management of resources and procedures (“workflow”)
Initiation and conduct of all business applications (EAI)
Electronic secretariat and Document management (GED)
Internal (CTI) and external (e-mail) messages in the context of projects
Integration of data sent to and received from data warehouses (“data mining”)

The system offers a 360° view on each third party of concern to the enterprise, be that a client, employee, supplier, resource, event management, or project . . .

The system presents in real time, depending on access authorisation, the comprehensive third party situation (projects and actions to come, underway or completed, reservation, placing orders, fax, letters, cost estimates, marketing messages, invoices, monitoring telephone calls, claims for Aftersales, e-mail monitoring, etc.).

The system database is designed as an applications integration database. It is not an integrated management package. The database is therefore particularly easy to set up in the enterprise, and enables recovery within a few days of the data, information databases, models of documents, procedures and existing organisation charts, a task which otherwise needs months of ERP work.

The system includes a tool for creating office automation documents (word processing, spreadsheets and other documents from Windows compatible applications). The end-user no longer needs to take care over the location where he or she records files, nor even of the name given to the files.

The system also makes available to users their personal and group diary, and internal messaging system (memo express), and controls all e-mails (sending, receiving and classification of e-mails as part of projects known to the database).

Two complementary modes of work are offered to the end-users:
Local network on an enterprise workstation
On a portable PC (nomad workstations which have a small on-board database, which can be synchronised by replication).

The system provides user access from an Internet navigator, i.e. access not requiring the installation of a heavyweight client software package on a dedicated workstation. Implementation is based on the development of a light client able to connect to the database through the IP protocol.

2. Description of the Two Extended Tier Architecture

The constraints of having to ensure cooperation between light client workstations operating in a conventional 3-tier architecture, in a common database with heavy client workstations, makes such work a delicate matter.

The invention is based on an architecture close to the two-tier client server architecture, but suited to Internet, to ensure that code migration is simple and rapid. Based on this system, all the SQL queries of the system to the database are stored in the Java iSJS server and identified by a name. Processing is transcribed using the script language.

The system graphical interface is HTML. Hence, without having to analyse every page or understand the use of the database before beginning development, the software can be implemented by translation into Intranet version: the only things to change are the language and database access method.

Hence, a two-tier architecture can be kept to simplify migration. However, there is integration of all the benefits of a three-tier architecture to reduce maintenance and increase performance.

The first tier (the application and processing part), is made up of the Web server (containing HTML pages, and the data processing script), and the end-user's Web navigator.

The second tier is made up of the database server and the Java iSJS server. The first integrated upgrade involves the ability to split the second tier: the server database and the iSJS server may be installed on different servers. The iSJS server plays the role of controller and regulator of network traffic, and also plays the role of a gangway between enterprise database and Internet.

3. Light Client Operation

At user request, the navigator must first display the graphical interface and download the processing scripts. The end-user is also in a position to recover necessary data.

These two processes are in fact independent: for example, if the end-user wishes to display the diary of his or her week 2 at the same time as he or she is displaying week 10, it is no longer necessary to recharge the interface and the scripts.

Such an operation would appear natural in a local network application, but is classically forgotten in Web applications design, where the navigator makes systematic contact with the Web server in order to respond to the end-user. Given this, the server dataflow to the client is split into two parts: client server communication for data, and client server communication for the graphical interface and processing.

a) Communication Between Client and Database Server

To control the process, an applet (Java Client selected by iSJC), organises the most efficient possible communication with the iSJS server.

The transfer of data between the database and the iSJS server is rapid, but the execution of requests is heavy on resources.

Data transfer between the iSJS server and the iSJC client is more or less fast (depending on the Internet connection mode and data size). To optimise this part, caches are added on the iSJS server and on the iSJC client, to limit the transfer and query database transactions.

The iSJC client also includes requests for batch processing which may be dispatched as a background task. Finally, all the data transmitted between the iSJS server and the iSJC client are advantageously compressed in ZIP or other formats (and on client request, may be subjected to SSL or other type of encryption).

b) Communication Between Client and Web Server

The recovery of the graphical interface and scripts is entirely handled by the navigator, in a fast operation. The navigator cache is also used, which keeps all the down loaded material on the client hard disk: each page (and the corresponding script) is downloaded once on the first call. Finally, processing takes place rapidly on the client station (PC Windows computers are amply powerful enough).

Figure XX contains the illustration of how the application works. The iSJS server and iSJC client undertake parallel execution within their contexts (Web server and Web navigator respectively).

4. Benefits of this Architecture

While not being a pure three-tier architecture, this form of development provides the following benefits:
It is no longer a requirement to maintain multiple versions and consequently to update the client workstations. The update of the Web server updates all applications when accessed by client workstations.
Although a large scale client application with much overhead requires a specific set of installations for each version of Windows, and considerable development, using an installation tool of the InstallShield type, the light client system requires no installation.
The most powerful computers operate as servers, and the client computers need only a Web navigator and word processing or spreadsheet applications, etc. (typically Word and Excel or better, if the enterprise uses such office automation software).
   B—Choice of Tools
   1. Server Operating System:

The market is currently served by two solutions:
Microsoft with Windows 2000 Server
Linux/UNIX type solutions.

The two solutions are not really opposed, but rather complementary: Windows 2000 is very widely used in small and medium sized enterprises and local networks, whereas Linux or UNIX solutions are widely used on the net, as less costly and reputedly more stable.

Developments have been made in Windows in order to propose this solution as a priority to the majority of end-users.

2. Database Server

For reasons of ease and agility of introduction of the different universes (W2000 and Linux), enabling ease of installation of a complete nomad application (client-Web server and data server), on a single workstation basis, with the ability to work off-line, the development has been performed on Sybase SQLAnywhere Studio.

However, most publishers propose database servers suited to Internet applications. Therefore the servers such as SYBASE, ORACLE, MICROSOFT SQL, INTERBASE, POSTGRESQL and MYSQL should be taken into consideration with advantage.

Sybase SQLAnywhere Studio server is an object-oriented relational database server integrating the Java virtual machine and the ability to store Java classes and SQLJ format procedures. It also offers the ability to store Java classes in relational database tables. Hence, data access from a Java programme is simplified. JDBC, OLE-DB drivers are also available.

3. Language Used for Server Development

The three main language servers frequently found server side are:
Java Script/VB Script embedded in ASP pages hosted on a Microsoft Internet Information Server.
PHP script language.
Java language, in the form of servlets and Java Server Pages (JSP).

The ASP technology presents two disadvantages in regard to the invention:
a) It is executable only on a Windows server,
b) It is affected by low performance on access to the database: whilst the script languages are perfectly suited to light client use (due to their portability and simplicity in particular), this is not a judicious choice server side.

PHP scripts represent an attractive solution in the sense that they are executable by a large number of Web servers. However, like all scripts, their execution is slow and not suited to scaling up to heavier duty processing.

Server side, JSP and Servlets open up the full power of the JAVA language development, including portability, a large number of libraries (packages), real object-oriented language.

Execution is also faster.

This the reason why the last solution has been adopted for system deployment.

4. WEB Server

Web APACHE server is by far and away the most used on Internet, and runs as well on Linux as on Windows. Its administration is easy and identical for the two platforms, and the server distribution is therefore very simple. Another, not unimportant, point is that the Web APACHE server is integrated to many Java development tools. This therefore also simplifies the preparation of machine development.

5. Language Used for Client Development

Graphical Interface

Graphical interface in HTML, the Web standard.

Event Management

To remain as universal as possible and as close as possible to the code written on the server (in Java language), the preference is Java Script language, which is supported by a large number of navigators (Internet Explorer and Netscape in particular).

Communication Between Client and iSJS Server

Only Java applets can play this role, as they are particularly well-suited to Internet developments. The iSJC client is written in the same language as the server. In order to simplify their use from the language script, function libraries have been developed, used on all pages.

6. Development Tools

Graphical Interface and Scripts

Two tools are preferentially used: DreamWeaver and Visual Studio. The first is used to generate graphical interface, as it enables the simple display of the result as it appears on end-user screens. Visual Studio is used to generate event scripts and to integrate the necessary applets into Web pages.

Java Client Programmes

The applets must be developed and compiled in a specific manner for Internet Explorer, and it is therefore especially recommended to use a Microsoft development tool for this task. Visual J++ has been used.

Java Server Development

Sun Forte For Java has been used. It includes APACHE Web server, a CVS client, an HTML page editor (static or dynamic) and of course, high performance Java class editor with code writing help.

7. Definition of Necessary Client Configuration

As each navigator must, for the present time, own a specific version of the software, the system has been developed for the most widely used navigator, Microsoft Internet Explorer. Its widespread adoption also offers the greatest wealth of performance to developers. The client workstation therefore runs Microsoft Windows as its operating system.

C—Server Development

The final aim was to develop a Web application in the same way as one would develop an application in a two-tier client/server architecture. For this purpose, three servers are distinguished:
Database server
WEB server (containing HTML pages, event management script and remote downloadable iSJC)
iSJS (all servlets and Java class containing SQL requests) and the client connection algorithm.

iSJS is a set of servlets awaiting client connection through the Web server and which owns the jobs which it is capable of executing as procedures, so as to give the results back to the client.

Its architecture is wholly extendable, which means that new jobs and new servlets can be created to respond to specific needs, so enabling LSJS to serve as a platform for inter-application communication (EA).

1. Presentation of SERVLETS

SWServlet: this servlet is the basis of the Java iSJS server. It manages connections to the database and certain parameters enabling its connection to Internet (to an e-mail server, for example).

SWDatabaseServlet is responsible for processing the client requests requiring access to the database. Each request may require the execution of one or more jobs. The result is sent back to clients in a standard Java format (SSL encryption on request and ZIP compression).

SWXMLServlet is an SWDatabaseServlet sending data to clients in universal XML format. This is a format used for generating Word and Excel documents. The document generation principle will be detailed below.

SWFileServlet simulates a file server in the database (it uses systems tables capable of storing binary data). This is the servlet used to store Word and Excel documents (this servlet adopts the Oracle IFS principles).

SWWAPServlet: this SERVLET gives access to the database from WAP mobiles by means of a WML format interface.

SWSignInServlet: this last servlet is an administration tool servlet able to register new users. It is used in particular to create test users and make on-line presentations.

FIG. 4 shows a schematic presentation of classes, illustrating the iSJS server software architecture.

2. Presentation of Jobs

As seen above, jobs are the equivalent of procedures executed on the server at client request. Each job performs a specific piece of work or task, checking user e-mails, downloading files from database, or executing SQL requests. For a job to be recognised as executable by the IsJS server, it must implement the SWJob interface. When a client post requests job execution, it gives the iSJS server its name (name of Java class) and a list of parameters (name of downloaded file or SQL request to be executed, for example).

The current diagram in FIG. 5 presents the most important jobs of the application:
SWUserIdentificationJob controls and checks users on connection.
SWMailJob is used to manage mails and user accounts.
   D—Client Development
   1. iSJC Applet

This class is used in all Web pages from the event management Java script code. It features many methods, each one of which makes it possible to evoke jobs on iSJS. The iSJS applet can manage the group dispatch of jobs, so as to optimise the volume of two-way messaging between clients and server. This class is an essential brick of the proposed architecture, and enables a Java script code of a two-tier server client architecture to execute in a high performance and reliable manner on Internet. The JClient class represents the iSJC applet, and exposes the methods required for job invocation (a getFile job for example downloads a file stored on the database).

The iSJC Client has a Reference to 4 Objects:

DocumentManager makes it possible to open a file by executing the associated Windows programme (Execute Word to open reference document FAX1245.DOC for example).
SWBuffer represents the client cache, and data from the server is stored in it and recovered form the Java script code.
Each job requested is stored in a Batch object, whose execution can be requested as part of a transaction.
The iSJS server returns the result in a BatchResult object.

The iSJS and iSJC client communicate as follows: the iSJC client establishes a batch which can be transmitted synchronously or asynchronously. This batch is analysed and executed on the iSJS server, as part of a transaction or otherwise. It then sends a BatchResult object which contains all the batch success or error codes of each job. In a general manner, SWBuffer preserves data while navigating from one page to another. It is also used to extend the Java script language and take advantage of the power of classic Java classes.

FIG. 6 illustrates the class diagram presenting the system database.

E—Document Generation

One of the advantages of the system is to generate, merge, record, classify and recover enterprise documents.

1. Standard Documents

All documents are automatically generated by the system from 4 components:
Word or Excel document model, which contains the format Of generic data.
Enterprise logo which is saved and separately inserted in the document before printing and then deleted before saving in the database.
Merger fields which indicate the location for merging of data extracted from the database (name and contact address for example).
Macro-instruction developed in the Visual Basic For Application language which enables data recovery from the database for merging into the document.
   2. Generation of New Document

The documents are created in the context of Projects: the user works on a customer file element and in a project relating to that file element.

The user selects a standard document in a list (commercial proposal, for example) iSJC client downloads the model, enterprise logo and opens it in Word or Excel (provided they are available of the client workstation).

On opening, the model macro executes and connects to the iSJS server (or precisely to the SWXMLServlet), and requests a predefined export from the database in XML format. It then merges the XML data with the standard document, and the document is numbered and saved temporarily on a local basis.

On exiting the project HTML page, the list of all documents created during the work session is proposed. A request to save documents on the server for longer-term use can be made.

F—Benefits

The development undertaken to allow invention execution (namely the iSJS server and iSJC client couple), is an excellent tool to carry two-tier client server applications to the Web.

An enterprise which has control over one or more specific client server applications can convert them into Intranet application in three simple stages:
Generation of graphical interface in HTML format (depending on development tools, this creation can be done by simple conversion).
Extraction of SQL request form the application and storing them in the iSJS server.
Developing events management scripts in Java Script.

The benefits provided by the invention are proven: stability, performance, deployment, accessibility and economy.

The advantages of N-tier client server applications are available: the application is accessible by Intranet, and on the Internet, from a simple Web navigator. Its deployment is simplified (installation of a single server machine). The communication protocol used between the iSJC client and the iSJS server is optimised. Furthermore, the iSJS server is robust and it supports a great number of simultaneous accesses.

The HTML format graphical interface is very light and can be customised by simply changing style sheets.

The client e-mail system offers the power of free “Webmails” such as Hotmail and Yahoo! Without nevertheless forcing the user to exit his or her work environment.

The user, or the enterprise administrator, configures the list of mail accounts into the system, and then requests checking new mails for all addresses or only for some. The user can also consult the headers and size of mails without downloading them, and may decide to delete suspect messages (spam or virus) without reading them. Finally, when the user sends or receives an e-mail, the user can classify them, not only in his or her personal mail box, but also in the project or third party file element to which the mail is attached.

A chat module can be attached to the system. The user will then have three means of communication available:
1. E-mail, consulted to contact third parties (customers or prospects, for example).
2. Memo Express, which is an asynchronous internal messaging system between end-users.
3. Chat to enable direct communication with other enterprise users simultaneously connected to the server. The data so exchanged are saved into the database and will allow for relevant multi-criteria search (Knowledge Management).

The system also advantageously proposes WAP access. This mode of access is a bonus, although it is true that WAP has not yet encountered great success. It is likely that the experience acquired through WML will accelerate the development of a GPRS interface.

G-Upgrades

The manager of a system database may be selected to benefit from recent database server upgrades (storage procedures, reference integrity), and for ease of integration to EAI platforms.

Refinement may take place as required of privileges and access rights to data, of graphical interface customisation for individual end-users, and the provision of foreign languages (with date format and corresponding digital decimal separators).

Note: all the brandnames cited above are the registered names of their respective owners

1. Multi-tier networked computer architecture intended to permit access to a personal resources environment via a network such as Internet, from various access points corresponding to different types of client workstation, characterised in that the computer architecture comprises:
a standard relational database server tier, comprising a database manager able to execute on request all operations on data in the database, which database contains both data and documents in a manner proper to each user, by constituting the organised and unique end-user storage space,
a communication tier on the network comprising a communication server and client software with the ability to communicate together in a standard network format, and
an intermediate software layer for the server connected on the one hand to the database server tier and on the other hand, to the communication tier, and comprising a set of servlets with the ability, in response to requests from the communication tier, to execute procedures corresponding operations of a type pre-defined in the database manager, using different servlets corresponding to different types of client workstation.

2. Architecture as set out in claim 1, characterised in that the client software is a standard Internet navigator.

3. Architecture as set out in claim 1 or 2, characterised in that the communications tier defines two distinct communication channels, on the one hand for specific graphical interface information for each type of client workstation, and on the other hand, for dispatching data or documents to or from the client workstation.

4. Architecture as set out in any one of claims 1 to 3, characterised in that the said user storage space contains, in the database, all the files executable by standard applications at the database server level, or at the client workstation level, and end-user data.

5. Multi-tier computer architecture to enable access to a personal resources environment via a network such as Internet from various points of access corresponding to different client workstation types, characterised in that it comprises:
a standard relational database server tier comprising a database manager able to execute on request all operations on data in the database, which database contains in a manner proper to each user, both data and documents setting up the organised and unique user space, and the database manager comprising remote operating system functionalities in relationship with said storage space,
a communication tier on a network comprising a communication server and a client software able to communicate together on a standard network format, and
an intermediate software layer server connected on the one hand to the database server tier and on the other hand, to the communications tier, and comprising a set of servlets able in response to requests from the communication tier to cause the execution by the database manager of the functionalities of said remote operating system.

6. Architecture as set out in claim 5, characterised in that the client software is a standard Internet navigator.

7. Architecture as set out in claim 5 or 6, characterised in that the communication tier defines the two distinct communication channels, on the one hand for graphical interface information specific to each type of client workstation, and on the other hand, for transmission of data or documents to or from the client workstation.

8. Architecture as set out in any one of claims 5 to 7, characterised in that said user storage in the database space contains all of the files executable by standard applications, at the database server level or at the client workstation level, and user data.
